(19) United States
(12) Patent Application Publication
(10) Pub. No.: US 2015/0015441 A1
(43) Pub. Date: Jan. 15, 2015

(54) METHODS FOR PROVIDING POSITIONING SERVICE FOR A WIRELESS DEVICE IN AN WIRELESS NETWORK AND RELATED WIRELESS DEVICES

(71) Applicant: MediaTek Inc., Hsin-Chu (TW)

(72) Inventors: Tsung-Yu CHIOU, Zhudong Township (TW); Yu-Chuan LIN, New Taipei City (TW)

(21) Appl. No.: 14/326,712

(22) Filed: Jul. 9, 2014

Related U.S. Application Data
(60) Provisional application No. 61/844,021, filed on Jul. 9, 2013.

(51) Int. Cl. G01S 1/02

(52) U.S. Cl. CPC G01S 1/02
USPC 342/386

(57) ABSTRACT

Methods for providing positioning service for a wireless device within a wireless network are provided. First, at least one positioning signal is received by a first wireless device, wherein, each of the at least one position signal is received from at least one wireless device other than the first wireless device and each indicates the positions of the at least one wireless device other than the first wireless device. The position of the first wireless device is then determined according to the at least one positioning signal received from the at least one wireless device.

### CROSS REFERENCE TO RELATED APPLICATIONS

This application claims the benefit of U.S. Provisional Application No. 61/844,021, filed Jul. 9, 2013, the entirety of which is incorporated by reference herein.

### BACKGROUND OF THE INVENTION

1. Field of the Invention

The disclosure relates generally to wireless communication systems and related methods, and, more particularly to wireless communication systems and related methods for providing positioning services for wireless devices in a wireless network.

2. Description of the Related Art

Recently, portable devices, such as handheld devices, have become more and more technically advanced and multifunctional. For example, a handheld device may have telecommunications capabilities, e-mail message capabilities, an advanced address book management system, a media playback system, and various other functions. Due to the increased convenience and functionality of the devices, these devices have become necessities of life.

As user requirements and behaviors change, a handheld device may be equipped with a GNSS receiver such as a global positioning system (GPS) receiver for providing location-based services that depend on positioning systems to determine device location. Satellite-based positioning systems, such as GPS, Global Navigation Satellite System (GNSS), and Galileo, can provide high accuracy, but require a clear line of sight between the satellites and the handheld device to provide a position determination. Consequently, satellite positioning systems are largely ineffective for positioning handheld devices that lack sufficient satellite visibility to determine a location. Method for determining the position of a handheld device in an area where the satellite positioning signals are unavailable are referred to as “indoor positioning”. For example, if the handheld device is disposed inside of a structure (e.g. a building, a shopping mall and so on), the GPS positioning signals are unavailable so that the handheld device may be unable to determine its position based solely on the GPS satellites. Some technologies, such as WiFi, Bluetooth, magnetic, RF fingerprinting, MEMS and iMES technologies, are currently provided for achieving indoor positioning. These technologies, however, require database maintenance or can only be used privately, thus are costly and inconvenient to use.

Therefore, it is desired to provide a more attractive method for providing positioning services for wireless devices in a wireless network.

### BRIEF SUMMARY OF THE INVENTION

Wireless devices and related methods for providing positioning service for a wireless device within a wireless network are provided.

An embodiment of a method for providing positioning service for a wireless device in a wireless network includes the steps of: receiving, by a first wireless device, at least one positioning signal, wherein, each of the at least one position signal is received from at least one wireless device other than the first wireless device and each indicates the positions of the at least one wireless device other than the first wireless device; and determining the position of the first wireless device according to the at least one positioning signal received from the at least one wireless device.

Another embodiment of a wireless device includes a wireless module and a controller module. The wireless module is arranged for performing wireless transceiving to and from a wireless network. The controller module is arranged for receiving at least one positioning signal via the wireless module, wherein, each of the at least one position signal is received from the at least one wireless device and each indicates the positions of the at least one wireless device and determining the position of the first wireless device according to the at least one position signal received from the at least one wireless device.

Methods for providing positioning service for a wireless device in a wireless network may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a wireless communication system of the invention;

FIG. 2 is a flowchart of an embodiment of a method for providing positioning service in a wireless network of the invention;

FIG. 3 is a flowchart of another embodiment of a method for providing positioning service in a wireless network of the invention;

FIG. 4 is a flowchart of another embodiment of a method for providing positioning service in a wireless network of the invention;

FIG. 5 is a flowchart of an embodiment of a method for providing positioning service in a wireless network of the invention; and

FIG. 6 is a schematic diagram illustrating another embodiment of a wireless communication system of the invention.

### DETAILED DESCRIPTION OF THE INVENTION

Wireless communication systems and related methods for providing positioning services for wireless devices in a wireless network are provided.

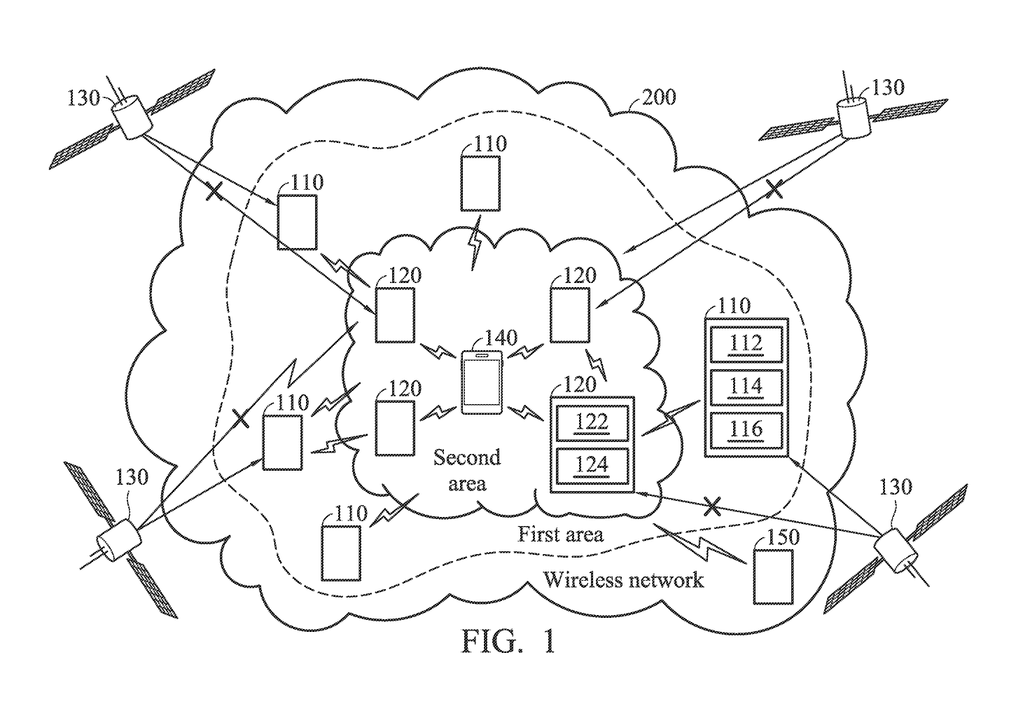

FIG. 1 is a schematic diagram illustrating an embodiment of a wireless communication system of the invention. The wireless communication system 100 of the invention at least comprises a plurality of wireless devices 110, one or more first wireless devices 120 and a plurality of positioning satellites 130. In one embodiments, each of the wireless devices 110 may be disposed within view of positioning satellites 130 where Global Navigation Satellite System (GNSS) (e.g. GPS) signals are available while the first wireless device 120 is disposed out of view of positioning satellites 130, where the GNSS signals are unavailable. For example, in one embodiment, the wireless devices 110 may be disposed on different sides or edges of a structure (e.g. a building, a shopping mall and so on) where the GPS signals are available and the first wireless device 120 may be disposed inside of the structure where the GPS signals are unavailable. Because the GPS signals are unavailable, there are no GPS signals inside of the structure, and thus the first mobile wireless device 120 may not able to locate its position through the GPS signals while being positioned in the second area even if it is equipped with a GPS receiver.

Each of the wireless devices 110 may be an electronic device that includes satellite positioning and wireless networking functionalities, such as a smartphone, a PDA (Personal Digital Assistant), a laptop computer, a tablet computer, a mobile telephones, a camera, a gaming system, and other mobile wireless devices. The first wireless device 120 may be an electronic device that includes wireless networking functionality. For example, the first wireless device 120 may be an electronic device which is the same as the wireless device 110 or another type of wireless device, such as a smartphone, a PDA (Personal Digital Assistant), a laptop computer or a tablet computer. In some embodiments, the wireless devices 110 and/or the first wireless devices 120 may be non-mobile or disposed at a fixed position.

The wireless devices 110 and the first wireless devices 120 are configured to communicate via a wireless network 200, such as a wireless local area network (WLAN). The wireless network 200 may be a network in compliance with the IEEE 802.11 specification such as the IEEE 802.11v specification. Any number of additional devices not shown in FIG. 1 may be connected to and/or accessible via the wireless network 200. For example, access points, servers, etc. may be connected to the wireless network 200 directly or through a different network (e.g., a wide area network, the Internet, etc.) and accessible to the wireless devices 110 and/or the first wireless devices 120. For example, the wireless device 110 and the first wireless device 120 may communicate with each other directly through a wireless network communication or a near-field communication (NFC), such as an infra-red (IR), or Bluetooth protocol, WiFi and so on, or they may communicate with each other indirectly through the server of a network. In some embodiments, each of the wireless device 110 and the first wireless device 120 are within a limited distance, and are communicating with each other through a wireless communication protocol, such as an IEEE 802.11v specification or the like.

The wireless device 110 may further comprise a wireless module 112 for performing the function of wireless transmission and reception to and from a cellular station or the first wireless device 120. To further clarify, the wireless module 112 may comprise a baseband unit (not shown) and a radio frequency (RF) unit (not shown). The baseband unit may contain multiple hardware devices to perform baseband signal processing, including analog-to-digital conversion (ADC)/digital-to-analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the radio access technology (RAT) in use. Also, the wireless device 110 further comprises a controller module 114 for controlling the operation of the wireless module 112 and other functional components, such as a display unit and/or keypad serving as the MMI (man-machine interface), a storage unit storing the program codes of applications or communication protocols, or others. In one embodiment, the wireless network 200 may be a WLAN network and the wireless device 110 may be a user equipment (UE) in compliance with the IEEE 802.11v specification and other related specifications of the WLAN technology, and the invention is not limited thereto.

To be more specific, the controller module 114 controls the wireless module 112 for providing a positioning service for determining the position of a wireless device in the wireless network 120.

The first wireless device 120 comprises a wireless module 122 which is similar to the wireless module 112 for performing the function of wireless transmission and reception to and from a cellular station or other wireless devices in the wireless network 200. The first wireless device 120 further comprises a controller module 124 for controlling the operation of the wireless module 122 and other functional components, such as a display unit and/or keypad serving as the MMI (man-machine interface), a storage unit storing the program codes of applications or communication protocols, or others. To be more specific, the controller module 124 controls the wireless module 122 for providing a positioning service for determining a position of a wireless device in the wireless network 120.

Each wireless device 110, also referred to as a reference access point (AP), is disposed in a first area where GNSS signals are available, so that its position can be determined based on GNSS signals received from a plurality of positioning satellites 130 via the GNSS receiver 116. The wireless device 110 can then broadcast the beacon signals together with positioning signals to the wireless network 200 via the wireless module 112. Positioning signal may include position information indicating the position of the wireless device 110 and range information which may be used to calculate a range or distance between the wireless device 110 and a receiving end later. To be more specific, the positioning signals are signals in compliance with related specifications of the WLAN technology such as the IEEE 802.11v specification and the wireless device 110 may be an AP in compliance with the IEEE 802.11v specification or other related specifications. The first wireless device 120, also referred to as a target AP, can receive the positioning signals via the beacon signal from one or more wireless devices 110. Upon receiving the beacon signal together with positioning signals from the wireless network 200, the first wireless device 120 may then calculate its position based on the received positioning signals. For example, in one embodiment, the first wireless device 120 may decode the positioning signals received from a number of wireless devices 110 to obtain the position of each of the wireless devices 110 and calculate a distance to the wireless device 110 therefrom, and then determine its position based on the positions of the wireless devices 110 and respective distances calculated. The methods for measuring the distance may include, for example, time-of-arrival (TOA), signal strength, and phase estimation, and the invention is not limited thereto.

In one embodiment, a method for providing positioning service for a wireless device in a wireless network is further provided.

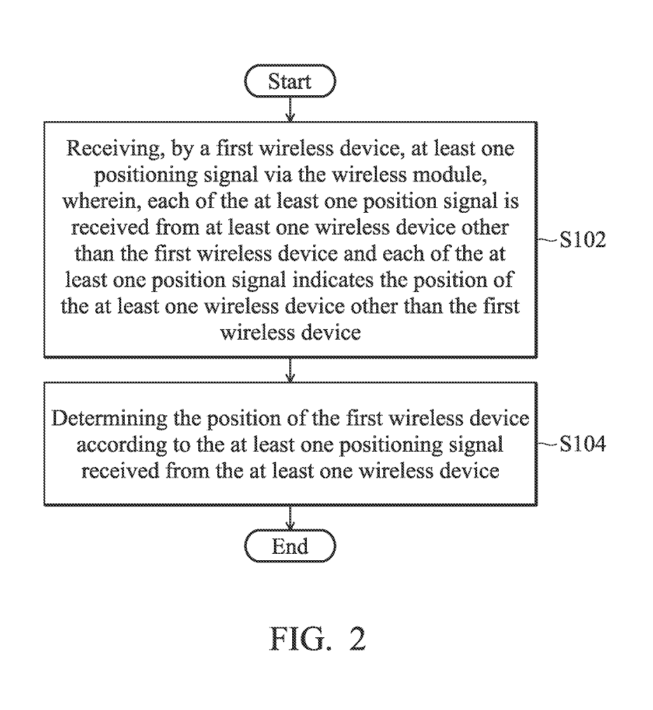

FIG. 2 is a flowchart of an embodiment of a method for providing positioning service for a wireless device in a wireless network of the invention. Please refer to FIGS. 1 and 2. The method can be applied to a wireless device within a wireless communication system such as the first wireless device 120 of the wireless communication system 100 including at least one wireless device as shown in FIG. 1, wherein each first wireless device may be an electronic device that includes wireless networking functionality, such as a portable device, e.g. a PDA, a PDA phone, a smartphone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the wireless devices are disposed on a first area of the wireless network where GNSS signals are available while the first wireless devices are disposed on a second area of the wireless network (e.g. an area within the first area) where GNSS signals are unavailable. For example, the wireless devices may be disposed on different sides or edges of a structure (e.g. a building, a shopping mall and so on) where the GPS signals are available and the first wireless device may be disposed inside of the structure where the GPS signals are unavailable. Each wireless device may further comprise a GNSS (e.g. GPS) receiver for receiving a positioning signal from the GNSS (e.g. GPS) satellites. As the wireless devices are disposed on the first area where GNSS signals are available, they can be synchronized to GPS time in advance by using its local GPS receiver.

In step S102, the controller module 124 of the first wireless device 120 receives at least one positioning signal via the wireless module 122, wherein, each of the at least one position signal is received from at least one wireless device other than the first wireless device 120 (e.g. the wireless device 110) and each of the at least one position signal indicates the position of the at least one wireless device other than the first wireless device. To be more specific, each wireless device 110 may generate a first positioning signal including position information indicating its own position and range information which may be used to calculate a range or distance from it and broadcast beacon signals with the generated first positioning signal to the wireless network 200. Then, in step S104, the controller module 124 further determines the position of the first wireless device according to the at least one positioning signal received from the at least one wireless device. To be more specific, the first wireless device 120 may receive at least one available beacon signals from a portion or all of the wireless devices 110 via the wireless network 200 through its wireless module 122 and calculate its position based on the received first positioning signals. In some embodiments, the at least one positioning signal may be received from via beacon signal, wherein the beacon signal is received as a broadcasted message. For example, the first wireless device 120 may decode first positioning signals received from the wireless devices 110 to obtain the position of each wireless device 110, calculate the distance to each wireless device 110 therefrom, and then determine its position based on the positions of the wireless devices 110 and respective distances calculated. Therefore, the position of the first wireless device 120 within the second area where the GPS signals are unavailable can be determined without requiring maintenance of any database. In some embodiments, after the position of the first wireless device 120 has been determined, the first wireless device 120 may further perform navigation according to the position of the at least one wireless device.

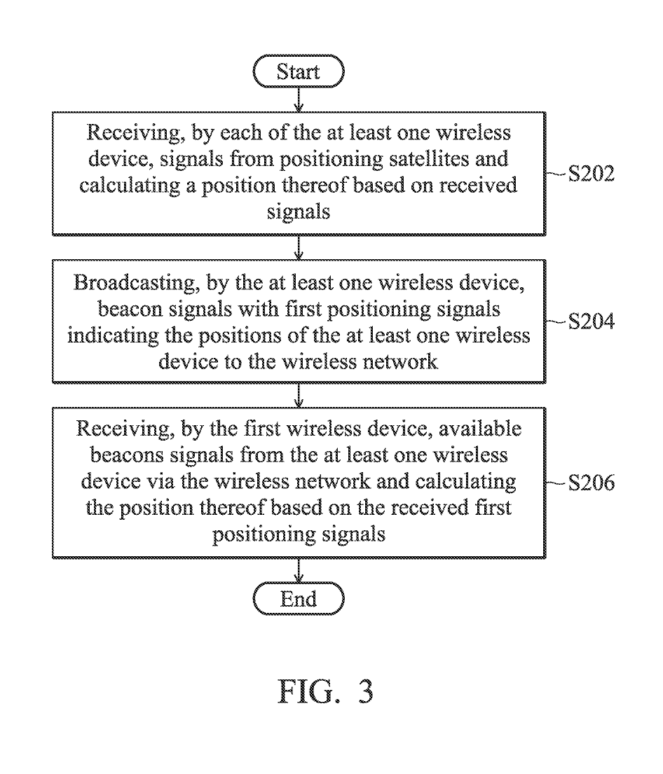

FIG. 3 is a flowchart of an embodiment of a method for providing positioning service in a wireless network of the invention. Please refer to FIGS. 1 and 3. The method can be applied to a wireless communication system with a plurality of wireless devices such as the wireless communication system 100 as shown in FIG. 1, wherein each wireless device may be an electronic device that includes wireless networking functionality, such as a portable device, e.g. a PDA, a PDA phone, a smartphone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the wireless devices are disposed on a first area of the wireless network where GNSS signals are available while the first wireless devices are disposed on a second area of the wireless network (e.g. an area within the first area) where GNSS signals are unavailable. For example, the wireless devices may be disposed on different sides or edges of a structure (e.g. a building, a shopping mall and so on) where the GPS signals are available and the first wireless device may be disposed inside of the structure where the GPS signals are unavailable. Each wireless device may further comprise a GNSS (e.g. GPS) receiver for receiving a positioning signal from the GNSS (e.g. GPS) satellites. As the wireless devices are disposed on the first area where GNSS signals are available, they can be synchronized to GPS time in advance by using its local GPS receiver.

First, in step S202, each of the wireless devices 110 receives signals from positioning satellites 130 via its GPS receiver and calculates a position thereof based on the received signals. For example, the wireless device 110 may receive GPS positioning signals from four or more GPS satellites via its GPS receiver and then calculate its position based on the received GPS positioning signal.

After calculating the position, in step S204, the wireless devices 110 broadcast beacon signals with first positioning signals indicating the positions of the wireless devices 110 to the wireless network 200. To be more specific, each wireless device 110 may generate a first positioning signal including position information indicating its own position and range information which may be used to calculate a range or distance from it and broadcast beacon signals with the generated first positioning signal to the wireless network 200.

The beacon signal with the generated first positioning signal broadcast by each wireless device 110 may then be received by any first wireless device 120 which is in proximity to it via the wireless network 200.

Upon entering into proximity with one or more wireless devices 110, in step S206, the first wireless device 120 may then receive available beacon signals from a portion or all of the wireless devices 110 via the wireless network 200 through its wireless module 122 and calculate its position based on the received first positioning signals. For example, the first wireless device 120 may decode the first positioning signals received from the wireless devices 110 to obtain the position of each wireless device 110, calculate the distance to each wireless device 110 therefrom, and then determine its position based on the positions of the wireless devices 110 and respective distances calculated. Therefore, the position of the first wireless device 120 within the second area where the GPS signals are unavailable can be determined without requiring maintenance of any database.

In one embodiment, the first wireless device 120 can be a device without a GPS receiver. In another embodiment, the first wireless device 120 can be a device with a GPS receiver in which the GPS function of the GPS receiver is deactivated when it is within the second area.

In some embodiments, after the positions of one or more first wireless device 120 have been determined, these first wireless devices 120 with determined positions together with the wireless devices 110 can be further utilized as reference nodes or reference APs to determine a position of a second wireless device 140 disposed in a third area in or inside of the second area. For example, in one embodiment, the third area may be an area inside of the second area.

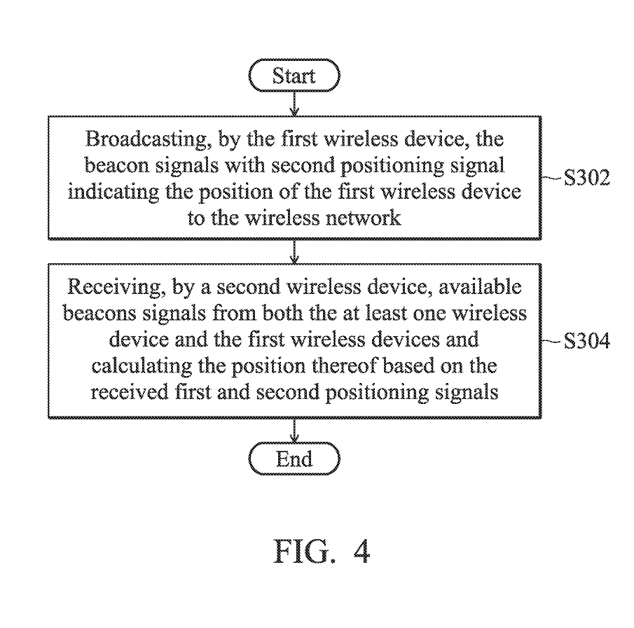

FIG. 4 is a flowchart of another embodiment of a method for providing positioning service in a wireless network of the invention. Please refer to FIGS. 1 and 4. The method can be applied to a wireless communication system with a plurality of wireless devices such as the wireless communication system 100 as shown in FIG. 1, wherein each wireless device may be an electronic device that includes wireless networking functionality, such as a portable device, e.g. a PDA, a PDA phone, a smartphone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the wireless devices 110 are disposed on a first area of the wireless network 200 where GNSS signals are available while the first wireless devices 120 are disposed in a second area (e.g. an area within the first area) of the wireless network 200 where GNSS signals are unavailable. For example, the wireless devices 110 may be disposed on different sides or edges of a structure (e.g. a building, a shopping mall, and so on) where the GPS signals are available and the first wireless device 120 may be disposed inside of the structure where the GPS signals are unavailable. The second wireless device 140 may further comprise a third wireless module (not shown) which is similar to the wireless modules 112 or 122 for performing wireless communication with the wireless and/or the first wireless devices, and the user of the second wireless device 140 is roaming within the second area. In this embodiment, it is assumed that the positions of the wireless devices 110 and the positions of the first wireless devices 120 have already been determined using the aforementioned method. As the second wireless device 140 is disposed in the third area (e.g. an area in or inside of the second area) where GNSS signals are unavailable, its position is unknown and should be determined.

In step S302, the first wireless device 120 broadcasts beacon signals with a second positioning signal indicating the position of the first wireless devices 120 to the wireless network 200. To be more specific, the first wireless device 120 may generate a second positioning signal including position information indicating its position and range information which may be used to calculate the range or distance from it and broadcast the beacon signals with the generated second positioning signal to the wireless network 200 via the wireless module 122. The second wireless device 140, which is in proximity to the wireless devices 110 and second wireless device 120, may then receive the beacon signals from the wireless devices 110 and second wireless device 120 via the third wireless module.

Upon entering into proximity of the wireless devices 110 and second wireless devices 120, in step S304, the second wireless device 140 may then receive available beacon signals from a portion or all of the wireless devices 110 and the first wireless device 120 via the third wireless module and calculate its position based on the received first and second positioning signals. For example, the second wireless device 140 may decode the first and second positioning signals received from the wireless devices 110 and the first wireless devices 120 to obtain the position of each wireless device 110 and the position of each second wireless device 120 and calculate the distance to each wireless device 110 or second wireless device 120 therefrom, and then determine its position based on the positions of the first and second wireless devices and respective distances calculated.

In one embodiment, the second wireless device 140 can be a device without the GPS receiver. In another embodiment, the second wireless device 140 can be a device with the GPS receiver in which the GPS function of the GPS receiver is deactivated. The second wireless device 140 may then perform indoor positioning within the second area and navigation to a specific position in the second area after its position has been determined.

In some embodiments, a position of a third wireless device 150 configured in a fourth area which is out of the first area can be further determined based on the beacon signals broadcast by the wireless devices 110 and/or the first wireless device 120. For example, the fourth area may be an area out of the first area where the GNSS signals are also available. In this embodiment, determination of the position of the third wireless device 150 may be performed by receiving available beacon signals from a portion or all of the wireless devices 110 and/or the first wireless device 120 and calculates its position based on the received first and/or second positioning signals. It is understood that, in this embodiment, the determination of the position of the third wireless device 150 can be performed regardless whether the GNSS signals are received.

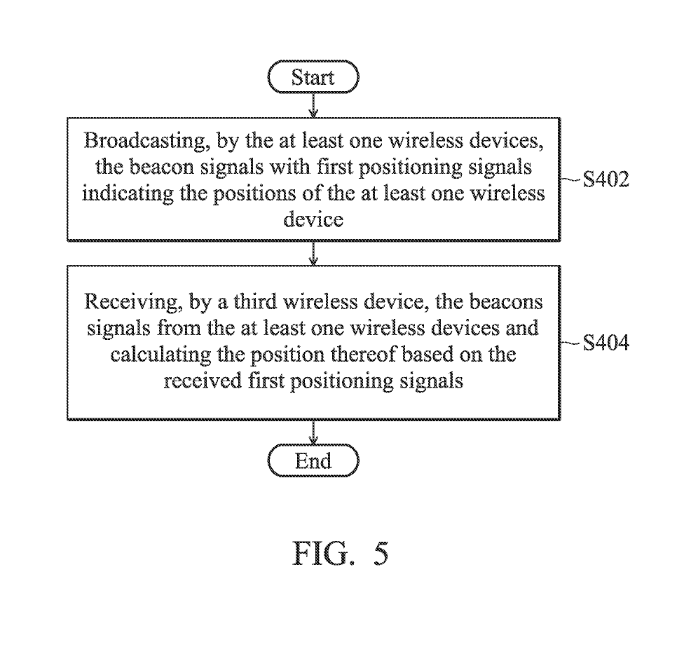

FIG. 5 is a flowchart of an embodiment of a method for providing positioning service in a wireless network of the invention. Please refer to FIGS. 1 and 5. The method can be applied to a wireless communication system with a plurality of wireless devices such as the wireless communication system 100 as shown in FIG. 1, wherein each wireless device may be an electronic device that includes wireless networking functionality, such as a portable device, e.g. a PDA, a PDA phone, a smartphone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the first wireless devices are disposed in a first area of the wireless network where GNSS signals are available while the fourth wireless device is disposed in a fourth area which is out of the first area where GNSS signals are also available. For example, the first wireless devices may be disposed on different sides or edges of a structure (e.g. a building, a shopping mall and so on) where the GPS signals are available and the fourth wireless device may be disposed outside of the structure where the GPS signals are also available. The third wireless device 150 may further comprise a fourth wireless module (not shown) which is similar to the first or second wireless module for performing wireless communication with the first and/or second wireless devices.

In step S402, each of the wireless devices 110 broadcasts beacon signals with the first positioning signal indicating the positions of the wireless devices 110 to the wireless network 200. To be more specific, each wireless device 110 may generate the first positioning signal including position information indicating its position and range information which may be used to calculate a range or distance from it and broadcast the beacon signals with the generated first positioning signal to the wireless network 200 via its wireless module 112. The third wireless device 150 which is in proximity of the wireless devices 110 may then receive the beacon signals from the wireless devices 110 via the fourth wireless module.

Upon entering into proximity of the wireless devices 110, in step S404, the third wireless device 150 may then receive available beacon signals from a portion or all of the wireless devices 110 via the wireless network 200 via the fourth wireless module and calculate its position based on the received first positioning signals. For example, the third wireless device 150 may decode the first positioning signals received from the wireless devices 110 to obtain the position of each wireless device 110 and calculate a distance to each wireless device 110 therefrom, and then determine its position based on the positions of the wireless devices 110 and the respective distances calculated.

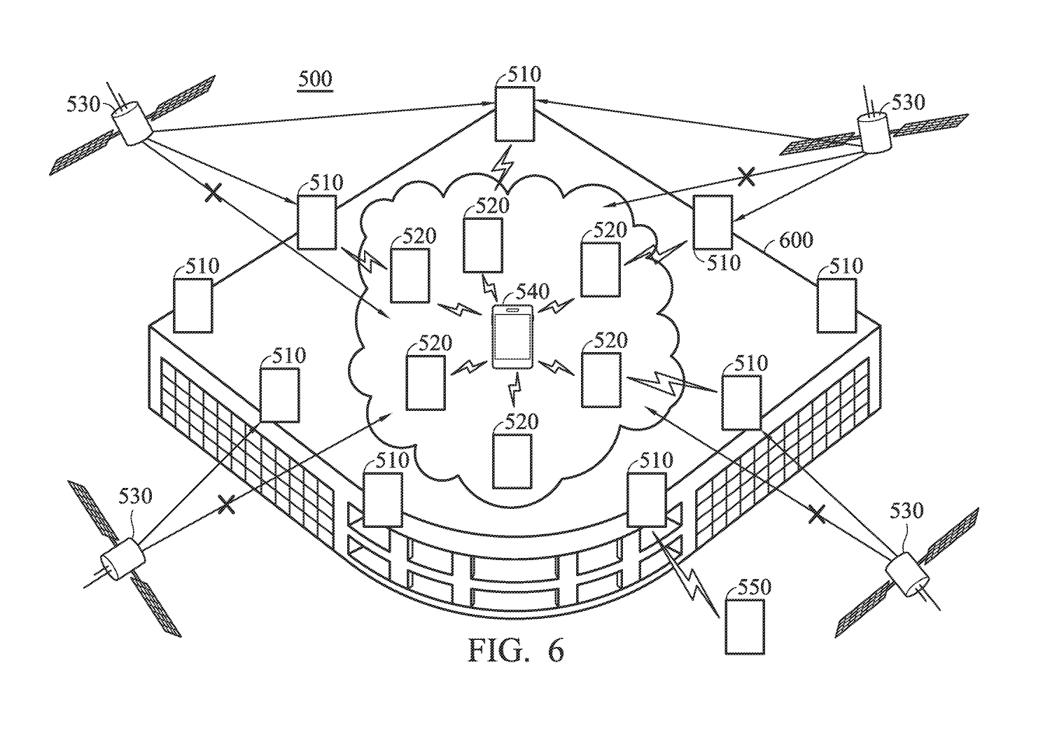

For explanation, a wireless communication system for providing positioning service in a wireless network in a structure (e.g. a shopping mall) is illustrated as an example in this embodiment, and those skilled in the art will understand that the present invention is not limited thereto. FIG. 6 is a schematic diagram illustrating another embodiment of a wireless communication system of the invention.

As shown in FIG. 6, the wireless communication system 500 at least comprises a number of first wireless devices 510, a number of second wireless devices 520, a plurality of positioning satellites 530, at least one third wireless device 540 and at least one fourth wireless device 550. Each of the first wireless devices 510 at least includes a first wireless module and a GPS receiver for receiving a GPS positioning signal from the positioning satellites 530. Each of the second wireless devices 520 at least includes a second wireless module for performing wireless communication in the wireless network. The third wireless device 540 at least includes a third wireless module for performing wireless communication in the wireless network. The fourth wireless device 550 at least includes a fourth wireless module for performing wireless communication in the wireless network. The first wireless devices 510 are disposed on different sides or edges of a shopping mall 600 where the GPS signals are available, the second wireless device 520 are disposed in a second area which is inside of the shopping mall 600 (e.g. in a vendor's store of the shopping mall 600) where the GPS signals are unavailable, the third wireless device 540 is disposed on a third area which is inside of the second area, and the fourth wireless device 550 is disposed on a fourth area which is outside of the shopping mall 600.

First, each of the first wireless devices 510 is synchronized to the GPS time by using its local GPS receiver. For example, each of the first wireless devices 510 may receive GPS signals from a number of positioning satellites 530 and calculate its own position based on received GPS signals.

After the position has be calculated, each of the first wireless devices 510 then broadcasts the beacon signals with its respective positioning signal indicating the respective position to the wireless network. The second wireless device 520 in each store receives the beacon signals from the first wireless devices 510 via the second wireless module and calculates its position based on the received positioning signal. After obtaining the position, the second wireless devices 520 then broadcast the beacon signals with the respective positioning signals indicating the respective positions via the second wireless module.

The third wireless device 540 may then receive the available beacon signals from both the first wireless devices 510 and the second wireless device 520 via the third wireless module and calculate its position based on the received first and second positioning signals. For example, the third wireless device 540 may decode the first and second positioning signals received from the first wireless devices 510 and the second wireless devices 520 to obtain the position of each first wireless device 510 and the position of each second wireless device 520 and calculate a distance to each first wireless device 510 or the second wireless device 520 therefrom, and then determine its position based on the positions of the first and second wireless devices and respective distances calculated. After the position of the third wireless device 540 has been determined, the third wireless device 540 may perform indoor positioning (UE-based positioning) and navigation to the vendor's store. Similarly, the fourth wireless device 550 outside the shopping mall 600 may also receive the beacon signals from the first wireless devices 510 via the fourth wireless module to perform positioning and navigation to the shopping mall 600 as well.

Therefore, the wireless communication systems and methods for providing positioning service in a wireless network of the invention can achieve indoor positioning for providing positioning service in the area where the GNSS signals are unavailable through wireless communication, e.g. the WiFi beacon communication channel and proximity discovery in WiFi, for reference wireless devices and is easy to deploy the reference wireless devices without any survey efforts of determining the position of each reference wireless devices. Moreover, according to the wireless communication systems and methods for providing positioning service in a wireless network of the invention, maintenance of a database of positions and fingerprint parameters of the reference wireless devices are not necessary, thus easy in implementation and saving cost.

Methods for providing positioning service, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for providing positioning service for a wireless device within a wireless network, comprising:
receiving, by a first wireless device, at least one positioning signal, wherein, each of the at least one position signal is received from at least one wireless device other than the first wireless device and each indicates the positions of the at least one wireless device other than the first wireless device; and
determining the position of the first wireless device according to the at least one positioning signal received from the at least one wireless device.

2. The method of claim 1, wherein the at least one positioning signal is received via beacon signal.

3. The method of claim 2, wherein the beacon signal is received as a broadcasted message.

4. The method of claim 1, wherein determining the position of the first wireless device further comprises obtaining position information of the at least one wireless device and range information ranging from the first wireless device to the at least one wireless device from the at least one positioning signal and determining the position of the first wireless device according to the position information and the range information.

5. The method of claim 1, wherein the first wireless device further performs navigation according to the position of the at least one wireless device.

6. The method of claim 1, wherein the at least one wireless device is configured in a first area where Global Navigation Satellite System (GNSS) signals are available and the first wireless device is configured in a second area where the GNSS signals are unavailable.

7. The method of claim 1, further comprising:
generating, by the first wireless device, a first positioning signal indicating the position of the first wireless device to be transmitted to a second wireless device other than the first wireless device for determining the position of the second wireless device.

8. The method of claim 1, wherein the wireless network is a wireless network in compliance with IEEE 802.11v specification and the positioning signals are signals in compliance with IEEE 802.11v specification.

9. A wireless device, comprising:
a wireless module, performing wireless transceiving to and from a wireless network; and
a controller module, receiving at least one positioning signal via the wireless module, wherein, each of the at least one position signal is received from the at least one wireless device and each indicates the positions of the at least one wireless device and determining the position of the first wireless device according to the at least one position signal received from the at least one wireless device.

10. The wireless device of claim 9, wherein the at least one positioning signal is received via beacon signal.

11. The wireless device of claim 10, wherein the beacon signal is received as a broadcasted message.

12. The wireless device of claim 9, wherein the controller module further determines the position of the first wireless device by obtaining position information of the at least one wireless device and range information ranging from the first wireless device to the at least one wireless device from the at least one positioning signal and determining the position of the first wireless device according to the position information and the range information.

13. The wireless device of claim 9, wherein the first wireless device further performs navigation according to the position of the at least one wireless device.

14. The wireless device of claim 9, wherein the at least one wireless device is configured in a first area where Global Navigation Satellite System (GNSS) signals are available and the first wireless device is configured in a second area where the GNSS signals are unavailable.

15. The wireless device of claim 9, wherein the wireless network is a wireless network in compliance with IEEE 802.11v specification and the positioning signals are signals in compliance with IEEE 802.11v specification.
